(19) United States
(12) Patent Application Publication
(10) Pub. No.: US 2014/0279561 A1
(43) Pub. Date: Sep. 18, 2014

(54) ALPHANUMERIC KEYPAD FOR FUEL DISPENSER SYSTEM ARCHITECTURE

(71) Applicant: Gilbarco, Inc., Greensboro, NC (US)

(72) Inventors: Giovanni Carapelli, High Point, NC (US); Bruce Welch, Steinhatchee, FL (US)

(73) Assignee: Gilbarco, Inc., Greensboro, NC (US)

(21) Appl. No.: 14/210,286

(22) Filed: Mar. 13, 2014

Related U.S. Application Data
(60) Provisional application No. 61/791,745, filed on Mar. 15, 2013.

(51) Int. Cl. G06Q 20/40

(52) U.S. Cl. CPC G06Q 20/4012
USPC 705/71; 705/72

(57) ABSTRACT

A vending machine can include a secure payment platform comprising one or more secure components for communicating sensitive information, an alphanumeric keypad configured outside of the secure payment platform for receiving input., and a keypad application operating within the secure payment platform to obtain input received on the alphanumeric keypad.

### PRIORITY CLAIM

This application is based upon and claims the benefit of U.S. provisional application Ser. No. 61/791,745, filed Mar. 15, 2013, which is relied upon and incorporated herein by reference it its entirety for all purposes.

### TECHNICAL FIELD

The subject matter described herein relates generally to fuel dispensers, and more specifically to providing an alphanumeric keypad for data entry at fuel dispensers.

### BACKGROUND

Fuel dispensers typically include various payment components configured to handle sensitive payment information received from a user to effect payment for fuel dispensed to the user. The sensitive payment information is usually provided to the fuel dispenser via one or more components, such as a card reader and a PIN pad, sometimes referred to as a PIN entry device. Any sensitive payment information received by the PIN pad is generally encrypted and forwarded to a secure controller. Because the components are configured to handle the sensitive payment information, they are usually installed together in a secure zone a secure payment platform) subject to certain security requirements imposed on devices that handle such information, which may include a manual offline certification process.

Adding input devices to fuel dispensers may require manual recertification of the components to ensure that the input devices do not compromise security thereof. Where such input devices interact directly with the components in the secure zone, such as a display on the fuel dispenser to provide input prompts, the input devices may pose a security risk that would require recertification, at least because the input device may be compromised to request or otherwise obtain sensitive data from a user. Certification for the components, however, may be a laborious process, may not be granted, and/or may require obtaining a different level of certification.

### SUMMARY

The following presents a simplified summary of one or more aspects of the subject matter disclosed herein to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Various aspects described herein relate to providing an input device for use with components operating secure zone without including the input device in the secure zone, such that the input device is independently controlled. Using this configuration, the components in the secure zone can operate a signed gateway application related to the input device to prompt for and process input from the device. Usable prompts can be preconfigured in the components to mitigate unauthorized prompting for sensitive user information by compromising the gateway application. Moreover, the input device can include a key storage for validating and/or authenticating prompts from the components in the secure zone to mitigate occurrence of tampering with the components to prompt for sensitive information.

To the accomplishment of the foregoing and related ends, the one or more aspects comprise the features hereinafter fully described arid particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements, and in which:

FIG. 1 is a partially schematic, perspective view of a fueling environment in accordance with aspects described herein;

FIG. 2 is a partially schematic, front elevation view of a fuel dispenser that may be used in the fueling environment of FIG. 1 in accordance with aspects described herein;

FIG. 3 is a diagrammatic representation of components of a secure payment platform of a fuel dispenser in accordance with aspects described herein;

FIG. 4 is an example system for using an input device with a secure payment platform in accordance with aspects described herein;

FIG. 5 is an example configuration of an alphanumeric keypad in a retail environment in accordance with aspects described herein; and

FIG. 6 is an example methodology for processing requests to access a touch display.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to incorporating an input device for use by a secure architecture without including the input device in the secure architecture to maintain integrity of the secure architecture. The input device can be independently controlled, and/or secured, to facilitate operating outside of the secure architecture. A signed gateway application can be employed by the secure architecture to interface with the input device. Various mechanisms can used to ensure security of the input device. For example, the gateway application can store a set of prompts that can be used to prompt for input via the input device. Moreover, the input device can store keys or other security mechanisms to verify authenticity of an application requesting input from input device.

In other examples, existing components in the security architecture can be used to provide additional security around receiving input from the input device. In one example, in a retail device, activation of a PIN pad can cause verification of authenticity of applications executing on the fuel dispenser while the PIN pad is active. In this example, the gateway application can cause activation of the PIN pad when prompting for input via the input device to ensure only signed applications (e.g., the gateway application) can operate on the secure components until the PIN pad is deactivated. Once the input is received from the input device, the gateway application can deactivate the PIN pad.

Though aspects herein are illustrated and described as embodied in a fuel dispenser, it is to be appreciated that the aspects can be similarly applied to substantially any retail device that processes transaction payment or other processes involving confidential information while maintaining the ability to execute other applications, such as a vending machine, point-of-sale (POS) system., etc.

Certain aspects of the embodiments described herein are related to fueling environments, fuel dispensers, and user interfaces for fuel dispensers, examples of which may be found in U.S. patent application Ser. No. 12/287,688 (entitled “System and Method for Controlling Secure Content and Non-Secure Content at a Fuel Dispenser or Other Retail Device” arid filed on Oct. 10, 2008), Ser. No. 12/544,995 (entitled “Secure Reports for Electronic Payment Systems,” and filed on Aug. 20, 2009), Ser. No. 12/689,983 (entitled “Payment Processing System for Use in a Retail Environment Having Segmented Architecture,” and filed on Jan. 19, 2010), Ser. No. 12/695,692 (entitled “Virtual PIN pad for Fuel Payment Systems,” and filed on Jan. 28, 2010), Ser. No. 12/797,094 (entitled “Fuel Dispenser User Interface,” and filed on Jun. 9, 2010), Ser. No. 12/975,502 (entitled “Fuel Dispensing Payment System for Secure Evaluation of Cardholder Data,” and filed on Dec. 22, 2010), Ser. No. 13/041,753 (entitled “Fuel Dispenser Payment System and Method,” and filed on Mar. 7, 2011), Ser. No. 13/105,557 (entitled “Fuel Dispenser Input Device Tamper Detection Arrangement,” and filed on May 11, 2011), Ser. No. 13/117,793 (entitled “System and Method for Selective Encryption of Input Data During a Retail Transaction,” and filed on May 27, 2011), Ser. No. 13/197,440 (entitled “Fuel Dispenser Application Framework” and filed on Aug. 3, 2011), Ser. No. 13/220,183 (entitled “Remote Display Tamper Detection Using Data Integrity Operations” and filed on Aug. 29, 2011), Ser. No. 13/467,592 (entitled “Fuel Dispenser Input Device Tamper Detection Arrangement” and filed on May 9, 2012), Ser. No. 13/655,938 (entitled “Fuel Dispenser Using Interface System Architecture” and filed on Oct. 19, 2012), 61/704,158 (entitled “Application Hosting Within a Secured Framework” and filed on Sep. 21, 2012), and 61/731,211 (entitled “Fuel Dispenser User interface System Architecture” and filed on Nov. 29, 2012), U.S. Pat. No. 7,607,576 (entitled “Local Zone Security Architecture for Retail Environments” and issued on Oct. 27, 2009), and European patent application no. 1,408,459 (entitled “Secure Controller of Outdoor Payment Terminals in Compliance with EMV Specifications” and published on Apr. 14, 2004). Each of the foregoing applications and patent is hereby incorporated by reference as if set forth verbatim in its entirety herein and relied upon for all purposes.

FIG. 1 is a partially schematic, perspective view of a fueling environment 100 adapted to provide fuel and to accept payment for the dispensed fuel. Fueling environment 100 includes at least one fuel dispenser 200a and a central facility 102. Typically, one or more additional fuel dispensers, such as fuel dispenser 200b, may also be included within fueling environment 100. Fueling environment 100 may also include a canopy system 104 connected to central facility 102 provides shelter to fuel dispensers 200a and 200b.

Central facility 102 includes a point-of-sale device (POS) 106 and a site controller 108 and may include additional computing devices, such as cashier and/manager workstations. In the example illustrated POS 106 includes an associated card reader and payment terminal 110. Each of POS 106 and site controller 108 may also include a display, a touchscreen, and/or other devices, such as a printer. It should be understood that the functionality of POS 106, site controller 108, and any additional computing devices within central facility 102 may be incorporated into a single computer or server. Alternatively, these computing devices may be operatively interconnected via a local area network (LAN). An example of a suitable system that may be used in conjunction with subject matter described herein combines the functions of POS 106 and site controller 108, to which multiple payment terminals 110 may be operatively connected, is the PASSPORT system offered by Gilbarco Inc. of Greensboro, N.C.

It is to be appreciated that fueling environment 100 may include a number of other components to facilitate the dispensing of fuel. In the example provided by FIG. 1, for instance, fueling environment 100 includes two underground storage tanks (USTs) 112 and 114 configured to store fuel that is available for purchase. For example, USTs 112 and 114 may be stocked with respective grades of fuel. USTs 112 and 114 are in fluid communication with an underground piping network 116 to which dispensers 200a and 200b are connected. As a result, fuel stored within UST's 112 and 114 may be delivered to the dispensers for purchase. Moreover, in one example, dispensers 200a and 200b can obtain information regarding the USTs 112 and 114 (e.g., a tank level, an environment indicator, such as temperature around the tank, etc.), and can communicate the information to the POS 106, site controller 108, or other device to allow for tank monitoring and/or notification of safety issues.

FIG. 2 is a partially schematic, front elevation view of a fuel dispenser 200 that may be used as fuel dispensers 200a and 200b in the fueling environment of FIG. 1. Fuel dispenser 200 includes a user interface 202 that includes a first controller 204, a second controller 206, a display 208, a card reader 210, and a numeric pad 212. Controller 204 is operatively connected to display 208 and optionally to controller 206, while controller 206 is operatively connected to display 209, card reader 210 and numeric pad 212, and optionally controller 204. It is to be appreciated that user interface 202 may include other components, such as a cash acceptor and/or a receipt printer, etc.

In one example, controller 206 includes an Ethernet adapter for communicating with external sources, such as device 226, via a transmission control protocol and/or Internet protocol (e.g., transmission control protocol (TCP)/internet protocol (IP), user datagram protocol (UDP), etc. Alternatively, controller 206 may connect to other devices via a universal serial bus (USB) connection and configured to communicate via the USB connection or other wired or wireless (e.g., Bluetooth, wireless local area network (WLAN), etc.) connection. In one example, one or more of the controllers 204 and 206 may be included within devices of the fuel dispenser 200, such as display 208, display 209, personal identification number (PIN) pad (or PIN entry device (PED)) 212, etc., as described further herein, and in some examples, one or more of the controllers 204 and 206 may not be present, or maybe replaced by another controller where the remaining controller implements functionality such that the replaced controller is not needed.

For purposes of the ensuing explanation, it is to be appreciated that card reader 210 may be any device or combination of devices configured to receive data from payment cards supplied by users that contain sensitive or confidential account or payment information (referred to generally herein as sensitive information or confidential information). Card reader 210, for instance, may be a magnetic stripe card reader, a smart card reader, a contactless card reader, a radio frequency (RF) reader, or any combination thereof. Thus, the term “payment card” as used herein intended to encompass magnetic stripe cards, smart cards, contactless cards, and RF devices, as well as other forms of cards and devices that are configured to store and provide account information. Information received from such a payment card is referred to herein as “payment data” for purposes of explanation, while the portion of the payment data sufficient to identify the account associated with the payment card is referred to as “sensitive payment data.” Thus, it is to be appreciated that “payment data” as used herein may include both sensitive and non-sensitive payment information. Moreover, it is to be appreciated that “sensitive payment data” may include other confidential information, such as a PIN associated with the payment card, and is also referred to generally as “sensitive data,” “confidential information”, or similar terms.

In the presently-described example, card reader 210 is configured to accept payment data from various types of payment cards, including credit and debit cards, prepaid and gift cards, fleet cards, any local/private cards, etc. accepted by fueling environment 100. It should be appreciated that card reader 210 may also be configured to receive account information from non-payment and other cards, such as loyalty, frequent shopper, rewards, points, advantage, and club cards. Numeric pad 212 is also configured to receive payment data, such as the PIN associated with a payment card. For at least this reason, numeric pad 212 may be referred to in the ensuing explanation as a PIN pad.

Moreover, it is to be appreciated that fuel dispenser 200 also includes various fuel dispensing components configured to facilitate the delivery of fuel to a vehicle. For instance, fuel dispenser 200 additionally includes a piping network 214, a meter 216, a pulser 218, a valve 220, a hose 222, and a nozzle 224, which can be duplicated to allow delivery of multiple fuel grades. Controller 204 is operatively connected to one or more of these components, such as pulser 218 and valve 220, to control operation thereof and to manage the delivery of fuel by fuel dispenser 200. Piping network 214 is in fluid communication with underground piping network 116, as described in FIG. 1, to receive fuel from the USTs. Piping network 214, hose 222, and nozzle 224 are also in fluid communication to supply the fuel to a vehicle. In other examples described herein, fuel dispenser 200 may include one of controllers 204 and 206, in which case controller 206 may operate the fuel dispensing components instead (or in addition).

User interface 202 is configured to facilitate the dispensing of fuel and the acceptance of payment for the dispensed fuel. For instance, display 209 can be configured to provide instructions to a user regarding the fueling process, and/or display 208 can be configured to display totals during and at the completion of the transaction. Displays 208 and/or 209 can each be a liquid crystal display (LCD), light emitting diode (LED) display, plasma display, etc. In addition, displays 208 and 209 can each be a touchscreen or a non-touchscreen display. Card reader 210 and PIN pad 212 are configured to accept payment data (e.g., as provided by the user). That is, card reader 210 can be configured to receive account information from a payment card, such as a credit or debit card. PIN pad 212 is configured to at least receive information associated with the payment card, such as a PIN of a debit card, the billing postal (zip) code of a credit card, etc. As noted above, other devices may be included within user interface 202, which may also be configured to facilitate financial transactions for the dispensed fuel. For example, a cash acceptor may be configured to handle transactions involving cash payments, while a receipt printer is configured to print a receipt upon completion of the fueling process if desired.

User interface 202 may also be configured to exchange information with a user unrelated to the fueling transaction. For instance, display 209 may be configured to provide advertisements or other information to the user, such as regarding items available for sale in the associated convenience store. PIN pad 212 (or a set of soft keys, such as those referenced below) may be configured to receive a selection from the user regarding the displayed information, such as whether the user is interested in nearby amenities. In this regard, for example, PIN pad 212 can be used in conjunction with the card reader 210 and/or display 209 to communicate data that is not as sensitive as payment information as well.

For example, controller 206 can be a secure controller that is installed in a secure zone with components of the card reader 210, PIN pad 212, and/or display 209 (or a controller thereof). The secure zone, also referred to herein as a secure payment platform, can include various hardware and/or software components to ensure security of the components installed therein, detect hardware tampering with the components, etc. Though shown as deployed at a distance, it is to be appreciated that card reader 210, PIN pad 212 and controller 206 can be deployed near one another on a similar printed circuit board or nearby boards) to facilitate providing one or more anti-tampering shells or other tamper detection mechanisms around the components 206, 210, and 212. The secure controller 206 can operate as part of the card reader 210, PIN pad 212, etc. in one example. Similarly, the display 209 can connect to the secure controller 206 in the anti-tampering shell to ensure the display is not compromised to request entry of sensitive information, in one example.

The secure zone can be certified by one or more governing bodies, such as payment card industry (PCI) security counsel, Europay, Mastercard, Visa (EMV), etc. The certification can be provided based on various security mechanisms employed by the secure zone to mitigate tampering therewith to obtain sensitive information in an unauthorized manner. The described anti-tampering shell can be one such security mechanisms, and another can include control of the display 209 (or a related display controller) by the security controller 206 to ensure only signed authorized applications can gain access to the display 209, card reader 210, PIN pad 212, or other components in the secure zone at least based on occurrence of some events. For example, the display 209 can be used by third parties to display advertisements, etc., but when card reader 210 or PIN pad 212 are activated, the secure controller 206 can verify authenticity of a current application to allow only signed authenticated applications to use the display 209, card reader 210, PIN pad 212, etc. to protect from compromise of sensitive information input by the card reader 210, PIN pad 212, etc. Various controllers, processors, etc. can be utilized to provide such functions.

In this regard, the secure controller 206 can provide a software or firmware mechanism for controlling security of the components in the secure zone, and the anti-tampering shell can provide a physical mechanism to control the security. For example, the anti-tampering shell can detect removal of a component (or movement of the shell) and can accordingly power down related components to prevent unauthorized use. Thus, for example, the secure zone and/or related components can be certified based on the various security measures. Once certified, it can be desirable, where possible, to not disrupt the certified components, as such can require recertification—a manual and oftentimes laborious process. Thus, described herein are aspects related to incorporating an input device in a fuel dispenser without disrupting the certified components in the secure zone thereof.

As shown, an alphanumeric keypad 240 is installed in the fuel dispenser 200 and coupled to secure controller 206. As described, where secure controller 206 is inside of the PIN pad 212 or a unit including the PIN pad 212 and/or card reader 210, alphanumeric keypad 240 can be coupled to the related unit. The coupling can include connection via a wired connection (e.g., serial, Ethernet. USB, or similar connection), a wireless connection (e.g., Bluetooth, ZigBee, etc.), and/or the like. Moreover, communications between keypad 240 and secure controller 206 can be encrypted to provide a layer of security for input data received and/or requesting input via keypad 240 (to allow keypad 240 to verify authenticity of the request, which can prevent unauthorized use of the keypad 240). Keypad 240 can include a key entry portion 242 and a display 244 to display inputted characters. Key entry portion 242 can include physical keys, a flexible membrane, a touch display, and/or the like. Display 244 can include similar equipment as display 208 and/or 209, and can include a LCD or LED display, etc. Keypad 240 can include a controller (not shown) to facilitate receiving a request for input, receiving input via the key entry portion 242, displaying the input on display 242, providing the input to an entity requesting the input, verifying authenticity of a request for input, encrypting input data, and/or other functions described of the keypad 240 herein,

In an example, the secure controller 206 can execute a keypad application, which can be signed by an authenticated entity to allow execution thereof by secure controller 206. The keypad application can include a set of usable prompts to prevent unauthorized prompting for sensitive information. In another example, the keypad 240 can include storage for secure keys to facilitate authenticating prompts received from the keypad application to ensure integrity of the keypad application. This can also mitigate tampering via the keypad application. Moreover, secure controller 206 can enforce existing security measures on the keypad application to ensure authenticity thereof. For example, the keypad application can be a signed application such that rouge unsigned applications may not execute via secure controller 206 (and/or may not execute once the card reader 210, PIN pad 212, etc. is activated). By configuring the keypad 240 as a contained unit with its own display 244 and a separate application to manage communications therewith, security of the secure zone components can be maintained while allowing applications to request and receive input from the keypad 240.

Further, a fueling environment 100 (FIG. 1) can be configured such that fuel dispenser 200 may be operatively connected to a wide area network (WAN) 228, such as the Internet. It should be understood that fuel dispenser 200 may be connected either directly to WAN 228 or indirectly via one or more additional components, such as one or more devices 226. It is to be appreciated that the additional components may include routers, switches, gateways, and other devices that participate in the LAN referenced above. In one example, devices 226 can include one or more of POS 106, site controller 108 to which the fuel dispenser is directly connected, etc. Alternatively, fuel dispenser 200 is operatively connected to POS 106 and/or site controller 108 indirectly via the LAN. It should also be understood that other external resources, such as a server 230, may be operatively connected to WAN 228 and accessible to fuel dispenser 200 and/or fueling environment 100 (FIG. 1) via the WAN. For example, server 230 may be a server maintained by a financial institution to authorize and settle credit card payments. In an additional or alternative example, server 230 may comprise a media server to provide informational and/or advertising content.

FIG. 3 illustrates a system 300 for configuring an input device for use with a secure payment platform. System 300 comprises a secure payment platform 302, which can be configured in a retail device such as a fuel dispenser, as described, and can include various components secured by one or more hardware, firmware, or software mechanisms. Secure payment platform 302 includes a collection of certified components 304, which can be certified by a governing body. Certified components 304 can include a secure display 209, which can be operated by and/or an include a secure controller with a processor to execute applications on secure display 209, as described. Certified components 304 can also include a card reader 210 that communicates with the secure display 209 to provide card information to an application using the secure display 209, and a PED 212 to provide PIN entry or other numeric data (e.g., zip code) to the secure display 209 or a related application.

System 300 also includes a keypad 240 having keys 242 and a display 244. In this regard, keypad 240 can be substantially self contained and can have an independent controller for obtaining, displaying (on display 244), and providing input received on keys 242 to one or more applications (e.g., keypad application 306). Moreover, for example, keypad 240 can be independently powered as well. Secure payment platform 302 can execute the keypad application 306 to request and obtain input from keypad 240. Keypad application 306 can by a signed application, in one example, which allows the keypad application 306 to execute in the secure payment platform 302 (e.g., even when PED 212 is activated). It is to be appreciated that the keypad application 306 can execute on secure display 209 (e.g., on a processor that operates the secure display 209) or other processor in the secure payment platform 302 (not shown that leverages the secure display 209 to display certain content. The processor may or may not be part of the certified components 304, in one example, but in either case has access thereto.

In addition, keypad application 306 can store a set of security keys in storage 308 to authenticate keypad 240, prompts to provide the keypad display 244 or on secure display 209, security keys for encrypting the prompts for authenticity verification by keypad 240, and/or the like. Similarly, keypad 240 can store a set of security keys in storage 310 to authenticate itself with keypad application 306, a set of security keys to authenticate requests for input from keypad application 306, prompts for displaying on display 244 when requesting input via keys 242, etc.

For example, keypad 240 can authenticate with keypad application 306 using keys stored in storage 310 and/or 308. The keys can be provisioned to storage 310 and/or 308, and/or to keypad 240 and keypad application 306 for storing in storages 310 and/or 308, upon installing the keypad 240 in a related retail device, before installing the keypad 240 and/or secure payment platform 302 (e.g., in a clean room), and/or the like. In this regard, tampering with keypad 240 and/or installing a new rouge keypad can cause the authentication to fail at keypad application 306, and thus keypad application 306 can disallow input from the keypad 240. To facilitate such authentication, keypad 240 can include a secure processor that can have anti-tampering hardware to ensure the secure processor is not compromised, and/or the secure processor can be configured to authenticate the keypad 240 with keypad application 306 using the keys stored in storage 310. Where the keypad 240 is not authenticated, keypad application 306 can shut down or can otherwise not process input from keypad 240.

In addition, for example, keypad application 306 can store a set of prompts in storage 308 that can be used to request input from keypad 240. The prompts can include prompts requesting information that is not sensitive (e.g., no prompts for credit card number, social security number, billing information, etc. The prompts can be substantially fixed, and the keypad application 306 can refrain from providing an application program interface (API) or other interface functionality that modifies the prompts. Thus, keypad application 306 is limited on prompts it can display on secure display 209, or otherwise send to keypad 240 for displaying on display 244. In addition, keypad application 306 can encrypt prompts, requests for input, or other data related to input when communicating with keypad 240 using one or more keys stored in storage 308. Corresponding decryption keys can be stored in storage 310, and thus keypad 240 can verify authenticity of the data from keypad application 306 based on whether decryption using the keys stored in storage 310 is successful. If not, keypad 240 does not prompt for input, nor does it provide input received via keys 242 to keypad application 306, for example. In this example, the keypad 240 may beep on pressing of keys 242, but may not display any characters on display 244.

As described, in one example, secure display 209 can display a prompt indicating to input certain data via keypad 240, and the prompt can be one of a set provided by keypad application 306 (or otherwise retrieved from storage 308). In any case, keypad application 306 can execute on secure display 209, or a related secure controller or processor, and can requesting input from the keypad 240 and providing input received to secure display 209 or applications executing thereon. Input can be provided using keys 242, and the input can be sent from keypad 240 to keypad application 306 (e.g., when the input is completely received, which can be indicated by a certain key press, etc.). In addition, keypad 240 can encrypt the input, as described, and keypad application 306 can decrypt the output inside of secure payment platform 302. This can mitigate unauthorized access to the input outside of secure payment platform 302. In this regard, for example, keypad application 306 can provide an API to facilitate requesting and receiving input via keypad 240. As described, the encryption/decryption keys can be stored in storages 308 and 310 and provisioned to keypad 240 and keypad application 306. Applications executing on secure display 209 can request input from keypad 240 by calling API functions offered by keypad application 306, and keypad application 306 facilitates requesting and receiving the input via keypad 240. For example, the API can allow for selecting, one or more of the prompts stored in storage 308.

As depicted, secure payment platform 302 can also include a card reader basic input/output system (BIOS) application 312 that a POS 314 can use to obtain payment information from the card reader 210 in a secure manner to process a transaction. The card reader BIOS application 312, though not part of the certified components 304 is in the secure payment platform, and is thus at least physically secured by one or more components, as described. Communications between the card reader BIOS application 312 and the secure display 209 can be encrypted to mitigate unauthorized receipt of the information, for example. Similarly, keypad application 306 can communicate with secure display 209 using an encrypted link. In one example, POS 314 can communicate with keypad application 306 to request input via card reader BIOS application 312, which can call an API function of the keypad application 306 to obtain keypad 240 input., as described.

In one specific example, POS 314 can request input from keypad 240 via card reader BIOS application 312, which can occur over 2-wire between the POS 314 and a fuel dispenser or other retail device on which the secure payment platform 302 is deployed. The card reader BIOS application 312 can accordingly call the API of keypad application 306 to obtain the input via keypad 240. Keypad 240 can have been authenticated, as described, and POS 314 can specify one of a set of available prompts for obtaining the input. In another example, the prompts can be restricted to be used only when certain specific input sequences are specified by the POS 314 or card reader BIOS application 312.

In addition, card reader BIOS application 312, or another component of secure payment platform 302, can enable PED 212 for PIN or other data entry based on receiving the request for keypad 240 input or other activation of the keypad 240. In some systems, activation of the PED 212 can cause secure display 209 to verify authenticity of any content displayed and/or related applications executed by the secure display 209. The PED 212 can be activated with a local echo off so there is no physical evidence at it is activated, in one example. Keypad application 306 can then request secure display 209 (and/or display 244) to show the prompt. For example, if authentication fails, secure display 209 can refrain from displaying the content or executing the related applications. This can mitigate unauthorized prompts from being displayed on secure display 209 when the keypad 240 is activated for receiving input.

In this example, keypad application 306 can enable the keypad 240 to accept input. In this example, keypad 240 can be configured to otherwise not process input until such enablement is received from the keypad application 306. Keypad 240 can indicate when the keypad 240 input is completely received (e.g., which can be based on keypad 240 detecting a confirmation of completion, such as pressing an OK or enter button on the keypad 240, and/or the like), at which point keypad 240 can encrypt and communicate the input to keypad application 306. The keypad 240 can display pressed keys 242 on the display 244 in a local echo mode. If, however, the PED 21.2 is disabled during input at keypad 240, any input at keypad 240 can be invalidated. This can be performed by the card reader BIOS application 312 by filtering POS 314 messages to determine deactivation of the PED 212, by the keypad application 306 based on monitoring the status of the PED 212 in real-time, etc.

Once the input is received from keypad 240, keypad application 306 can accordingly obtain the keypad 240 input. Keypad application 306 can decrypt the keypad 240 input and provide to the card reader BIOS application 312 (e.g., in another encrypted communication) for sending to the POS 314 (e.g., in another encrypted communication, or as clear text, as described). Where card reader BIOS application 312 or other component of the secure payment platform 302 enabled PED 212, it can disable the PED 212 once the input is received. Thus, the POS 314 can communicate to receive input from keypad 240 outside of using the certified components 304 (other than to possibly display prompts via secure display 209, at which point the secure display 209 can enter PED 212 active mode to only allow signed content).

In one example, the keypad 240 can be used to support inputting fleet information as related to a given transaction back to the POS, such as an odometer reading on a vehicle using a fuel dispenser that comprises system 300 (or at least a portion thereof). The keypad 240 can include a secure processor, as described, with active tamper with manufacturer keys and/or authentication keys to allow pairing with the secure payment platform 302 (e.g., via keypad application 306 or otherwise), similar physical security as PED 212, at least two lines of alphanumeric display, a signed prompts table (e.g., stored in storage 310), which can be upgradeable with cryptographic authentication of a signature, battery backup, flexible membrane or keys, encrypted link to the keypad application 306, flash memory for storing the keys/prompts, certificates, encryption, etc. in storage 310, and/or the like.

FIG. 4 illustrates an example system 400 for providing an input device in a secure payment platform. System 400 includes an input device 402, which can be an alphanumeric keypad or substantially any input device for obtaining input outside of a secure payment platform for use with components communicating through the secure payment platform. System 400 also includes an input application 404 that operates within the secure payment platform, as described, a secure payment outdoor terminal (SPOT) 406 for allowing processing of payment at a location remote to one or more components that communicate transaction information to systems that clear the transaction, and a POS 408 for processing the transaction.

In the depicted transaction-specific example, SPOT 406 can provide card data received from a related card reader to the POS 408. This can cause POS 408 to obtain input from input device 402. For example, the card data can indicate a fleet card is used, and the POS 408 may determine to prompt for fleet information (e.g., odometer reading) as part of the transaction. Thus, POS 408 can transmit an input entry command 412 to input application 404. The input entry command 412 can be sent through SPOT 406, which can activate a PED based on receiving and forwarding the command to the input application 404 to force the SPOT 406 to display only signed content. Input application 404 can send a prompt display 414 command to SPOT 406 to render a prompt on the secure display instructing to use the input device 402. As described, the input application 404 is signed, such that the SPOT 406 can display content therefrom. Input device 402 can be used and can perform encrypted communications 416 with input application 404 to authenticate the input device 402, provide input on the input device 402 to input application 404, etc. The input application 404 can provide clear text input data 418 to the POS 408 based on that received using input device 402. In addition, SPOT 406 can deactivate the PED upon receiving the input data to forward to POS 408.

FIG. 5 illustrates an example configuration of a retail device that includes an alphanumeric keypad, as described herein. Configuration 500 includes a secure display 502 that has an associated PED 504. Keypad 506 is provided to allow input entry for applications that execute using secure display 502. Thus, a keypad application allows encrypted entry of input from keypad 506 for use with the secure display 502, and as shown in this Figure, secure display 502 can prompt for entry on keypad 506. The prompt displayed can be one of a set of available prompts, as described, and can be signed to allow display thereof when PED 504 is activated. In addition, the PED 504 can be activated as part of receiving input data from the keypad 506 to mitigate display of unauthenticated content on the secure display 502 during input on keypad 506.

Referring to FIG. 6, a methodology that can be utilized in accordance with various aspects described herein is illustrated. While, for purposes of simplicity of explanation, the methodology is shown and described as a series of acts, it is to be understood and appreciated that the methodology is not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 6 illustrates an example methodology 600 for obtaining input using a keypad configured outside of a secure payment platform. At 602, a request for input data is received from an application executing within a secure payment platform. The request can specify a prompt, one example, which can be one of a set of prompts that can be used as specified by the application or an application that manages a keypad. At 604, a PED is activated based on receiving the request. This can cause a secure display to display only signed content to mitigate compromise of the secure display while the PED is active. At 606, the one or more prompts can be displayed on the secure display. The prompts (or a related application that displays the prompts can be signed to allow for displaying the prompts. At 608, encrypted input can be obtained from an alphanumeric keypad. For example, if the secure display is compromised during this process, any input received from the keypad can be invalidated. At 610, the PED is deactivated based on obtaining the encrypted input to allow additional applications to use the secure display. At 612, the encrypted input can be decrypted using a stored decryption key. As described, the keys can be provisioned to the keypad and the application decrypting the input before installation. At 614, the input can be provided to the application.

While one or more aspects have been described above, it should be understood that any and all equivalent realizations of the presented aspects are included within the scope and spirit thereof. The aspects depicted are presented by way of example only arid are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

What is claimed is:

1. A vending machine, comprising:
a secure payment platform comprising one or more secure components for communicating sensitive information, wherein at least a portion of the secure payment platform is certified by payment card industry (PCI) security counsel;
an alphanumeric keypad configured outside of the secure payment platform for receiving input, wherein the alphanumeric keypad is not certified by the PCI security counsel; and
a keypad application operating within the secure payment platform to obtain input received on the alphanumeric keypad.

2. The vending machine of claim 1, wherein the keypad application authenticates the alphanumeric keypad prior to requesting the input from the alphanumeric keypad.

3. The vending machine of claim 2, wherein the keypad application commands a secure display in the secure payment platform to display a prompt for using the alphanumeric keypad as part of authenticating the alphanumeric keypad.

4. The vending machine of claim 3, wherein the prompt is selected from a set of preconfigured prompts signed using an authentic manufacturer signature.

5. The vending machine of claim 4, wherein the prompt is compliant with PCI.

6. The vending machine of claim 1, wherein the alphanumeric keypad is configured to authenticate a request from the keypad application related to obtaining input via the alphanumeric keypad.

7. The vending machine of claim 6, wherein the alphanumeric keypad comprises a memory that stores one or more keys for decrypting the request from the keypad application, and wherein the authenticating is based on decrypting the request.

8. The vending machine of claim 1, wherein the alphanumeric keypad comprises a display to display the received input.

9. The vending machine of claim 1, further comprising an application that requests alphanumeric keypad input from the keypad application using one or more function calls, wherein the secure payment platform activates a PIN entry device based at least in part on the one or more function calls.

10. The vending machine of claim 9, wherein the keypad application invalidates input received from the alphanumeric keypad where the PIN entry device is disabled.

11. The vending machine of claim 1, wherein the alphanumeric keypad is connected to a component of the one or more secure components by a wired or wireless connection.

12. The vending machine of claim 11, wherein the alphanumeric keypad and the component communicate over an encrypted link.

13. The vending machine of claim 1, wherein the secure payment platform comprises one or more hardware or software security mechanisms to ensure integrity of data communicated among the one or more secure components.

14. The vending machine of claim 1, wherein the alphanumeric keypad includes an anti-tampering device to detect and/or report detected movement near one or more components of the alphanumeric keypad.

15. A method for using an input device outside of a secure payment platform, comprising:
receiving a request for input data from an application executing within the secure payment platform, wherein the request specifies one or more of a set of prompts related to the input data;
activating a PIN entry device based on receiving the request;
displaying the one or more prompts on a secure display;
obtaining encrypted input from an alphanumeric keypad;
deactivating the PIN entry device;
decrypting the encrypted input using a stored decryption key; and
providing the input to the application.

16. The method of claim 15, further comprising authenticating the alphanumeric keypad using one or more security keys.
